(19) United States
(12) Patent Application Publication
(10) Pub. No.: US 2025/0377923 A1
(43) Pub. Date: Dec. 11, 2025

(54) IMAGE PROCESSING DEVICE AND IMAGE PROCESSING METHOD

(71) Applicant: SigmaStar Technology Ltd., Xiamen (CN)

(72) Inventors: CHING-CHUAN YANG, Hsinchu County (TW); CHENG-CHI HUANG, Hsinchu County (TW); WEI-CHIH TSAI, Hsinchu County (TW)

(21) Appl. No.: 18/986,850

(22) Filed: Dec. 19, 2024

(30) Foreign Application Priority Data
Jun. 6, 2024 (CN) 202410733868.6

(51) Int. Cl. G06F 9/455

(52) U.S. Cl. CPC G06F 9/45558; G06F 2009/45575

(57) ABSTRACT

An image processing device is coupled to an external memory and includes a memory, a first processor, and a second processor. The first processor is configured to perform the following steps: loading a virtual machine monitor to the external memory; loading a first virtual machine to the external memory; waking up the second processor; and loading a second virtual machine to the external memory. The second processor is configured to perform the following steps: executing the virtual machine monitor; and executing the first virtual machine. The first processor first loads the first virtual machine and then loads the second virtual machine, and the loading time of the first virtual machine is less than the loading time of the second virtual machine.

This application claims the benefit of China application Serial No. 202410733868.6, filed on Jun. 6, 2024, the subject matter of which is incorporated herein by reference.

### BACKGROUND OF THE INVENTION

### 1. Field of the Invention

The present invention generally relates to an image processing device, and, more particularly, to an image processing device executing multiple virtual machines and a method thereof.

### 2. Description of Related Art

The boot-up speed of an electronic device is one of the indicators of the performance of the electronic device. In order to accelerate the boot-up speed, the conventional electronic devices often adopt the following methods: (1) replacing a large and relatively complete operating system (hereinafter referred to as a rich OS, such as Linux, UNIX, Android, Windows, etc.) with a lightweight operating system (hereinafter referred to as a simple OS, such as a real-time operating system (RTOS) or a Non-OS process), where the complexity of the rich OS is greater than the complexity of the simple OS; or (2) simplifying the rich OS.

The disadvantage of method (1) is that, due to the poor software functionality and hardware support of a simple OS, the difficulty of application porting is relatively high. The disadvantage of method (2) is that, limited by the architectural design of the rich OS, the simplification results have their limitations, and the amount of booting time that can be shortened is limited.

### SUMMARY OF THE INVENTION

In view of the issues of the prior art, an object of the present invention is to provide an image processing device and an image processing method, so as to make an improvement to the prior art.

According to one aspect of the present invention, an image processing device is provided. The image processing device is coupled to an external memory and includes a memory, a first processor, and a second processor. The first processor is used to execute the following steps: loading a virtual machine monitor to the external memory; loading a first virtual machine to the external memory; waking up the second processor; and loading a second virtual machine to the external memory. The second processor is used to execute the following steps: executing the virtual machine monitor; and executing the first virtual machine. The first processor first loads the first virtual machine and then loads the second virtual machine, and the loading time of the first virtual machine is less than the loading time of the second virtual machine.

According to another aspect of the present invention, an image processing device is provided. The image processing device is coupled to an external memory and includes a memory and a processor. The processor is used to perform the following steps: loading a virtual machine monitor to the external memory; loading a first virtual machine to the external memory; executing the virtual machine monitor; executing the first virtual machine; and loading a second virtual machine to the external memory. The processor first loads the first virtual machine and then loads the second virtual machine, and the loading time of the first virtual machine is less than the loading time of the second virtual machine.

According to still another aspect of the present invention, an image processing method is provided. The image processing method is applied to an image processing device coupled to an external memory. The method includes the following steps: (A) loading a virtual machine monitor to the external memory; (B) loading a first virtual machine to the external memory; (C) executing the virtual machine monitor; (D) executing the first virtual machine; and (E) loading a second virtual machine to the external memory. Step (B) is performed earlier than step (E), and the loading time of the first virtual machine is less than the loading time of the second virtual machine.

The technical means embodied in the embodiments of the present invention can solve at least one of the problems of the prior art. Therefore, compared to the prior art, the present invention can accelerate the boot-up speed of an electronic device executing a complete rich OS.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the electronic device according to an embodiment of the present invention.

FIG. 2 is a flowchart of the image processing method according to an embodiment of the present invention.

FIG. 3 is a sequence diagram corresponding to FIG. 2.

FIG. 4 is a functional block diagram of the electronic device according to another embodiment of the present invention.

FIGS. 5A to 5B are flowcharts of the image processing method according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an image processing device and an image processing method. On account of that some or all elements of the image processing device could be known, the detail of such elements is omitted provided that such detail has little to do with the features of this disclosure, and that this omission nowhere dissatisfies the specification and enablement requirements. Some or all of the processes of the image processing method may be implemented by software and/or firmware and can be performed by the image processing device or its equivalent. A person having ordinary skill in the art can choose components or steps equivalent to those described in this specification to carry out the present invention, which means that the scope of this invention is not limited to the embodiments in the specification.

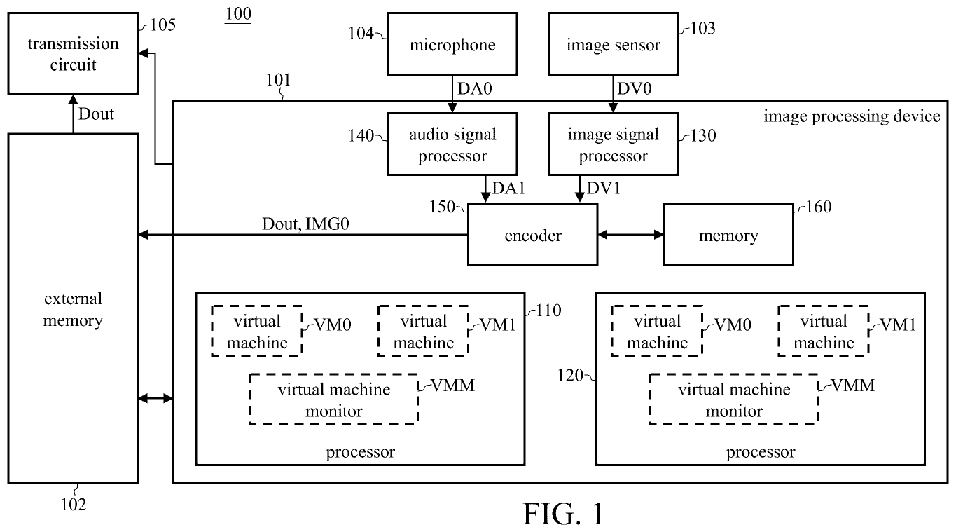

Reference is made to FIG. 1, which is a functional block diagram of the electronic device according to an embodiment of the present invention. The electronic device 100 includes an image processing device 101, an external memory 102, an image sensor 103, a microphone 104, and a transmission circuit 105. The image processing device 101 includes a processor 110, a processor 120, an image signal processor 130, an audio signal processor 140, an encoder 150, and a memory 160. The processor 110 and the processor 120 may be general-purpose processors or dedicated processors, etc., and the dedicated processor may be a neural network processor or an intelligent processor, etc. The external memory 102 may be a Dynamic Random Access Memory (DRAM), and the memory 160 may be a Static Random Access Memory (SRAM).

The image sensor 103 and the microphone 104 are respectively used to capture images and audio, and respectively generate an image data DV0 and an audio data DA0. The image signal processor 130 is coupled to the image sensor 103, and is configured to process the image data DV0 (including, but not limited to, calculating the brightness of the image data DV0 and controlling the exposure length of the image sensor 103 based on the brightness) to generate the processed image data DV1. The audio signal processor 140 is coupled to the microphone 104, and is configured to process the audio data DA0 (including, but not limited to, noise reduction and amplification) to generate the processed audio data DA1. The encoder 150 is coupled to the image signal processor 130, the audio signal processor 140, the memory 160, and the external memory 102, and is configured to encode the processed audio data DA1 and the processed image data DV1 to generate the multimedia data Dout, and store the multimedia data Dout into the external memory 102. Then, the image processing device 101 (more specifically, the processor 110 or the processor 120) controls the transmission circuit 105 to read out the multimedia data Dout from the external memory 102, and transmits the multimedia data Dout to a network or other electronic devices (including, but not limited to, a storage device). The multimedia data Dout includes at least one frame of picture.

The memory 160 can be used to temporarily store intermediate data generated by the encoder 150 during the encoding process.

The processor 110 and the processor 120 may be two independent processors, two cores of the same processor, or two cores from different processors. The processor 110 and the processor 120 both execute a virtual machine monitor VMM (also known as Hypervisor). The virtual machine monitor VMM manages the virtual machine VM0 and the virtual machine VM1 executed by the processor 110 and the processor 120. More specifically, the virtual machine monitor VMM allocates hardware resources (e.g., a processor) to the virtual machine VM0 or the virtual machine VM1 according to predefined rules (e.g., the priority of the virtual machine). The operating principle of the virtual machine monitor VMM is well known to people having ordinary skill in the art, so further elaboration is omitted for brevity.

In the following discussion, the priority of the virtual machine VM0 is higher than the priority of the virtual machine VM1, and the virtual machine VM0 and the virtual machine VM1 execute a simple OS and a rich OS, respectively. The image sensor 103, the microphone 104, the image signal processor 130, the audio signal processor 140, and the encoder 150 are controlled by the virtual machine VM0, while the transmission circuit 105 is controlled by the virtual machine VM1.

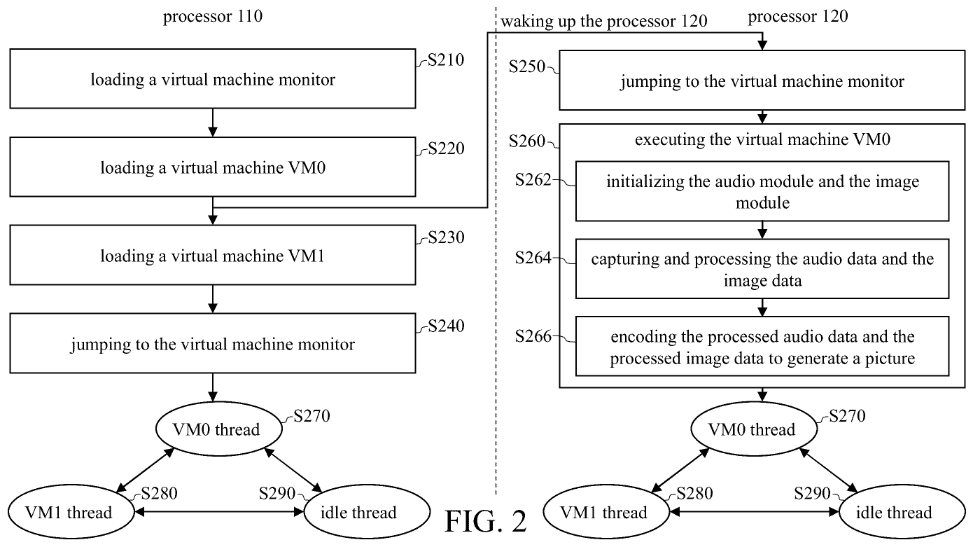

Reference is made to FIG. 2, which is a flowchart of the image processing method according to an embodiment of the present invention. The image processing method includes the following steps.

Step S210: The processor 110 loads the virtual machine monitor VMM to the external memory 102 (e.g., loads an image file of the virtual machine monitor VMM). In some embodiments, the processor 110 performs step S210 by executing a bootloader.

Step S220: The processor 110 loads the virtual machine VM0 to the external memory 102 (e.g., loads an image file of the virtual machine VM0). The processor 110 can perform step S220 by executing the bootloader.

After step S220 is completed, the processor 110 wakes up the processor 120 to perform steps S250 to S290 while it continues to perform steps S230 to S240 and steps S270 to S290.

Step S230: The processor 110 loads the virtual machine VM1 to the external memory 102 (e.g., loads an image file of the virtual machine VM1). In some embodiments, the processor 110 performs step S230 by executing the bootloader.

It should be noted that because the complexity of a rich OS is greater than the complexity of a simple OS (i.e., the image file of the virtual machine VM1 is larger than the image file of the virtual machine VM0), the loading time of the virtual machine VM1 is greater than the loading time of the virtual machine VM0.

Step S240: The processor 110 jumps to the virtual machine monitor VMM, which means executing the virtual machine monitor VMM.

It should be noted that the processor 110 executes the virtual machine monitor VMM (step S240) only after loading the virtual machine VM0 and the virtual machine VM1 (steps S220, S230). In other words, the virtual machine monitor VMM of this invention does not have the function of loading the virtual machine VM0 and the virtual machine VM1. Such a design can simplify the virtual machine monitor VMM, thereby shortening the execution time of step S210 (i.e., further accelerating the boot-up speed of the electronic device 100).

Step S250: The processor 120 jumps to the virtual machine monitor VMM.

Step S260: The processor 120 executes the virtual machine VM0. More specifically, in step S260 the processor 120 executes the three sub-steps: step S262, step S264, and step S266.

Step S262: The processor 120 initializes the audio module (including the microphone 104 and the audio signal processor 140) and the image module (including the image sensor 103 and the image signal processor 130).

Step S264: The processor 120 controls the audio module to capture and process the audio data DA0 and controls the image module to capture and process the image data DV0.

Step S266: The processor 120 controls the encoder 150 to encode the processed audio data DA1 and the processed image data DV1 to generate a picture IMG0 (a part of the multimedia data Dout), and stores the picture IMG0 into the external memory 102. The picture IMG0 is the first frame of picture generated by the electronic device 100 after booting.

After the processor 110 finishes loading the virtual machine VM1 (step S230) and jumps to the virtual machine monitor VMM (step S240), the processor 110 and the processor 120 then simultaneously execute the virtual machine monitor VMM. The virtual machine monitor VMM allocates the usage rights of the processor 110 and/or the processor 120 to the virtual machine VM0 (i.e., execute the VM0 thread (step S270)) or the virtual machine VM1 (i.e., execute the VM1 thread (step S280)) based on the priorities of the virtual machine VM0 and the virtual machine VM1, or controls the processor 110 and the processor 120 to enter an idle state (i.e., execute the idle thread (step S290)).

For example, after the picture IMG0 is generated, the virtual machine monitor VMM continues to allocate the hardware resources of the processor 120 to the virtual machine VM0 to generate more frames of pictures (step S270), and at the same time allocates the hardware resources of the processor 110 to the virtual machine VM1 to control the transmission circuit 105 to output the picture IMG0 and subsequent pictures (step S280).

It should be noted that the processor 120 is not exclusive to the virtual machine VM0, and the processor 110 is also not exclusive to the virtual machine VM1. For example, in certain situations (for instance, when there is no picture to be transmitted in the external memory 102), the virtual machine monitor VMM can allocate both the processor 110 and the processor 120 simultaneously to the virtual machine VM0. Similarly, the virtual machine monitor VMM can allocate both the processor 110 and the processor 120 simultaneously to the virtual machine VM1. In other words, whether it is a simple OS or a rich OS, both can obtain the computing power of more than one processor, which is more advantageous for the scheduling of the processors' resources.

As discussed above, because the priority of the virtual machine VM0 is higher than the priority of the virtual machine VM1, when the virtual machine VM0 and the virtual machine VM1 simultaneously request hardware resources from the virtual machine monitor VMM, the virtual machine monitor VMM prioritizes allocating hardware resources to the virtual machine VM0.

When neither the virtual machine VM0 nor the virtual machine VM1 requires hardware resources, the virtual machine monitor VMM controls the processor 110 and the processor 120 to execute the idle thread (step S290).

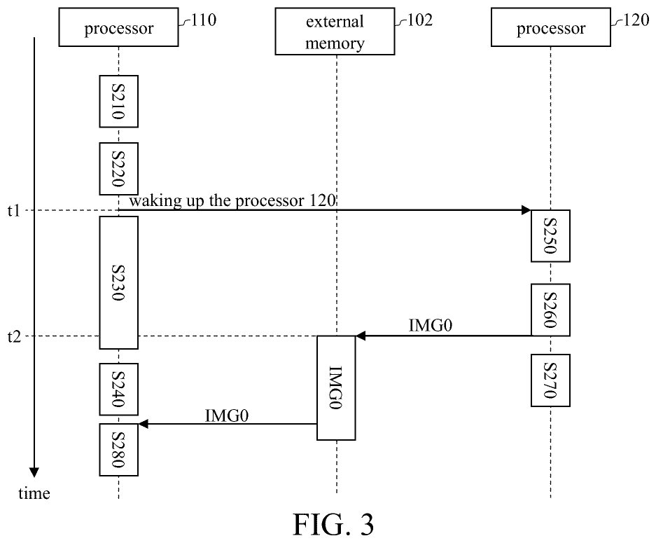

Reference is made to FIG. 3, which is a sequence diagram corresponding to FIG. 2. The processor 110 wakes up the processor 120 at the time point t1. Between the time point t1 and the time point t2, the processor 120 is performing step S250 and step S260 while the processor 110 is performing step S230. Due to the relatively large size of the rich OS (i.e., the loading time of the virtual machine VM1 is relatively long), when the processor 110 finishes loading the virtual machine VM1 (end of step S230), the processor 120 has already generated the picture IMG0 (at the time point t2). After generating the picture IMG0, the processor 120 executes the virtual machine VM0 to generate more frames of pictures (step S270). After loading the virtual machine VM1, the processor 110 executes the virtual machine monitor VMM (step S240), and then executes the virtual machine VM1 (step S280). In step S280, the processor 110 controls the transmission circuit 105 to read out the picture IMG0 from the external memory 102 and transmit the picture IMG0.

As shown in FIG. 3, the electronic device 100 of the present invention has generated at least one picture (the picture IMG0) before executing the rich OS (i.e., the virtual machine VM1). Compared to the prior art, the present invention significantly increases the boot-up speed of the electronic device 100 and enhances the user experience.

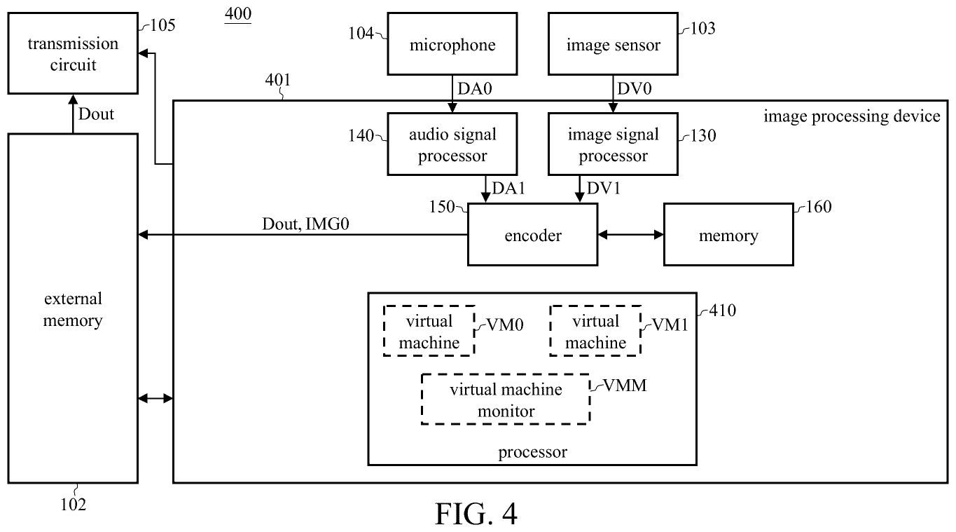

Reference is made to FIG. 4, which is a functional block diagram of the electronic device according to another embodiment of the present invention. The electronic device 400 is similar to the electronic device 100, except that in the image processing device 401, the number of processors is one (i.e., the processor 410).

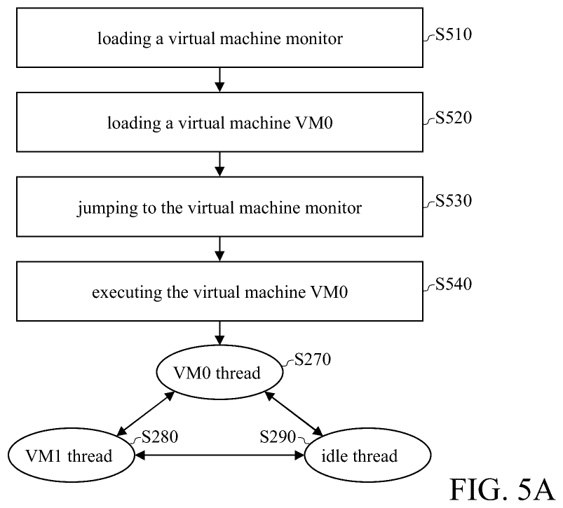

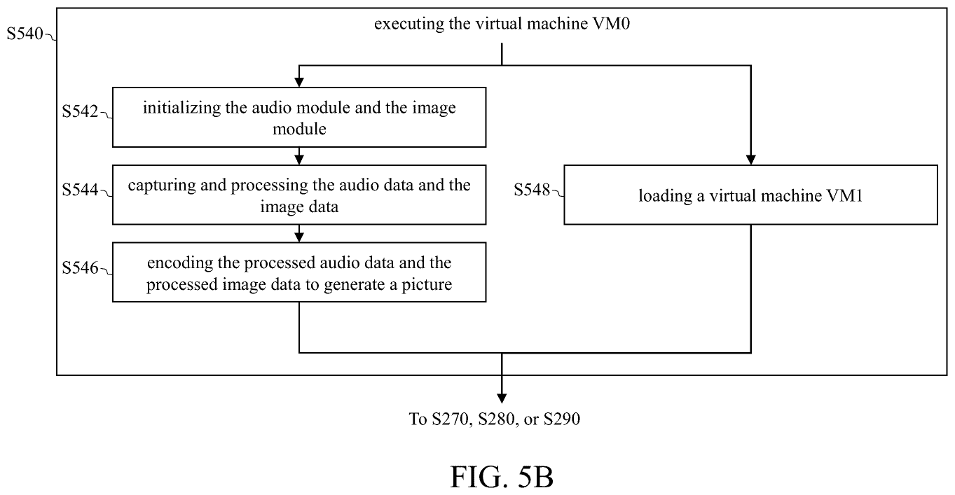

Reference is made to FIG. 5A to FIG. 5B, which are flowcharts of an image processing method according to another embodiment of the present invention. The process of FIGS. 5A to 5B is executed by the processor 410, wherein step S510, step S520, and step S530 are the same as step S210, step S220, and step S250, respectively, and the sub-steps of step S540 are shown in FIG. 5B. Reference is made to FIG. 5B. Step S540 includes sub-steps S542, S544, S546, and S548, and step S542, step S544, step S546, and step S548 are respectively the same as step S262, step S264, step S266, and step S230. More specifically, during the period when the processor 410 generates the picture IMG0 (steps S542 to S546), the processor 410 simultaneously loads the virtual machine VM1 in a time division multiplexing (TDM) manner (step S548). In other words, the processor 410 substantially executes step S548 and steps S542 to S546 simultaneously.

It should be noted that, due to the relatively large size of a rich OS (i.e., the loading time of the virtual machine VM1 is relatively long), when the processor 410 finishes loading the virtual machine VM1, the processor 410 has already generated the picture IMG0. In other words, the end time of step S546 is earlier than the end time of step S548.

The image processing device is intended to illustrate the invention by way of example and not to limit the scope of the claimed invention. People having ordinary skill in the art may apply the present invention to other types of electronic components in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image processing device coupled to an external memory, the image processing device comprising:
a memory;
a first processor; and
a second processor;
wherein the first processor is configured to execute following steps:
loading a virtual machine monitor to the external memory;
loading a first virtual machine to the external memory;
waking up the second processor; and
loading a second virtual machine to the external memory;
wherein the second processor is configured to execute following steps:
executing the virtual machine monitor; and
executing the first virtual machine;
wherein the first processor first loads the first virtual machine and then loads the second virtual machine, and a loading time of the first virtual machine is less than a loading time of the second virtual machine.

2. The image processing device of claim 1, wherein the first virtual machine executes a first operating system, the second virtual machine executes a second operating system, and the complexity of the first operating system is less than the complexity of the second operating system.

3. The image processing device of claim 1, wherein a priority of the first virtual machine is higher than a priority of the second virtual machine.

4. The image processing device of claim 1 further comprising:
an image signal processor configured to process an image data to generate a processed image data;
an audio signal processor configured to process an audio data to generate a processed audio data; and
an encoder coupled to the image signal processor and the audio signal processor and configured to encode the processed image data and the processed audio data to generate a picture;
wherein the second processor executes the first virtual machine to control the image signal processor, the audio signal processor, and the encoder, and when the second processor executes the first virtual machine, the first processor is loading the second virtual machine.

5. The image processing device of claim 4, wherein the picture is generated before the second virtual machine is completely loaded.

6. The image processing device of claim 4 further comprising:
a transmission circuit configured to transmit the picture;
wherein the first processor executes the second virtual machine to control the transmission circuit.

7. The image processing device of claim 1, wherein the first processor executes a bootloader to load the second virtual machine, and the first processor executes the virtual machine monitor only after loading the second virtual machine.

8. An image processing device coupled to an external memory, the image processing device comprising:
a memory; and
a processor configured to perform following steps:
loading a virtual machine monitor to the external memory;
loading a first virtual machine to the external memory;
executing the virtual machine monitor;
executing the first virtual machine; and
loading a second virtual machine to the external memory;
wherein the processor first loads the first virtual machine and then loads the second virtual machine, and a loading time of the first virtual machine is less than a loading time of the second virtual machine.

9. The image processing device of claim 8, wherein the first virtual machine executes a first operating system, the second virtual machine executes a second operating system, and the complexity of the first operating system is less than the complexity of the second operating system.

10. The image processing device of claim 8, wherein a priority of the first virtual machine is higher than a priority of the second virtual machine.

11. The image processing device of claim 8 further comprising:
an image signal processor configured to process an image data to generate a processed image data;
an audio signal processor configured to process an audio data to generate a processed audio data; and
an encoder coupled to the image signal processor and the audio signal processor and configured to encode the processed image data and the processed audio data to generate a picture;
wherein the processor executes the first virtual machine to control the image signal processor, the audio signal processor, and the encoder, and the processor generates the picture and loads the second virtual machine in a time division multiplexing manner.

12. The image processing device of claim 11, wherein the picture is generated before the second virtual machine is completely loaded.

13. The image processing device of claim 11 further comprising:
a transmission circuit configured to transmit the picture;
wherein the processor executes the second virtual machine to control the transmission circuit.

14. The image processing device of claim 8, wherein the second virtual machine is loaded to the external memory when the processor executes the first virtual machine.

15. An image processing method, applied to an image processing device coupled to an external memory, the method comprising:
(A) loading a virtual machine monitor to the external memory;
(B) loading a first virtual machine to the external memory;
(C) executing the virtual machine monitor;
(D) executing the first virtual machine; and
(E) loading a second virtual machine to the external memory;
wherein step (B) is earlier than step (E), and a loading time of the first virtual machine is less than a loading time of the second virtual machine.

16. The image processing method of claim 15, wherein the first virtual machine executes a first operating system, the second virtual machine executes a second operating system, and the complexity of the first operating system is less than the complexity of the second operating system.

17. The image processing method of claim 15, wherein a priority of the first virtual machine is higher than a priority of the second virtual machine.

18. The image processing method of claim 15 further comprising:
(F) processing an image data to generate a processed image data;
(G) processing an audio data to generate a processed audio data; and
(H) encoding the processed image data and the processed audio data to generate a picture;
wherein step (F), step (G), and step (H) are substantially executed simultaneously with step (E).

19. The image processing method of claim 18, wherein the picture is generated before the second virtual machine is completely loaded.

20. The image processing method of claim 15, wherein step (E) is a sub-step of step (D).
